(19) United States
(12) Patent Application Publication
(10) Pub. No.: US 2008/0285722 A1
(43) Pub. Date: Nov. 20, 2008

(54) COLLAPSIBLE INTRA-OPERATIVE CT SCANNER

(76) Inventor: James A. Bertolina, Portage, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/103,946

(22) Filed: Apr. 16, 2008

Related U.S. Application Data
(60) Provisional application No. 60/912,000, filed on Apr. 16, 2007.

(51) Int. Cl. H05G 1/02

(52) U.S. Cl. 378/197

(57) ABSTRACT

A CT scanner includes a gantry including a first arm and a second arm. One of the first arm and the second arm houses an x-ray source that generates x-rays, and the other of the first arm and the second arm houses a complementary flat-panel x-ray detector. The first arm is rotatable about an axis relative to the second arm. During a CT scan, the first arm is in a CT scanning position. When the CT scanner is no longer needed, the first arm is rotated relative to the second arm about the axis, allowing the first arm to move to a collapsed position. If another CT scan is required during a surgical procedure, the first arm is rotated about the axis from the collapsed position to the CT scanning position.

### REFERENCE TO RELATED APPLICATIONS

This application claims priority to U.S. Provisional Application No. 60/912,000 filed Apr. 16, 2007.

### BACKGROUND OF THE INVENTION

The present invention relates generally to a collapsible intra-operative CT scanner.

A prior art CT scanner includes a gantry that houses an x-ray source and an x-ray detector. The x-ray source generates x-rays, and the x-ray detector converts the x-rays from the x-ray source to visible light to create an image. A part of a patient is positioned in a space defined between the x-ray source and the x-ray detector. As the gantry rotates about an axis of rotation, a plurality of x-ray images are obtained that are used to generate a three-dimensional CT image.

In one prior art CT scanner, the gantry is connected to the ceiling by an arm. When a CT scan is taken, the gantry is in a scanning position relative to the ceiling. When the CT scanner is no longer needed, the gantry can be slid in a first direction relative to the ceiling from the scanning position to a remote position. If the CT scanner is again needed during the surgical procedure, the gantry can be slid in an opposing second direction relative to the ceiling from the remote position to the scanning position.

### SUMMARY OF THE INVENTION

A CT scanner includes a gantry including a first arm and a second arm. One of the first arm and the second arm houses an x-ray source that generates x-rays, and the other of the first arm and the second arm houses a complementary flat-panel x-ray detector. As the gantry rotates about a patient, the x-ray detector takes a plurality of x-ray images at a plurality of rotational positions which are used to generate a three-dimensional CT image.

The first arm is rotatable about an axis relative to the second arm. An outermost surface of the first arm extends a first distance from the axis, and an innermost surface of the second arm extends a second distance from the axis. The second distance is greater than the first distance.

A CT scan can be taken before or during a surgical procedure. During a CT scan, the first arm is in a CT scanning position. A lock can be used to secure the first arm in the CT scanning position. When the CT scanner is no longer needed, the lock is released to allow rotation of the first arm relative to the second arm about the axis. As the second distance is greater than the first distance, the first arm fits into a space defined between the axis and the inner surface of second arm, allowing the first arm to move to a collapsed position. If another CT scan is required during the surgical procedure, the first arm can be rotated about the axis from the collapsed position to the CT scanning position.

These and other features of the present invention will be best understood from the following specification and drawings.

### BRIEF DESCRIPTION OF THE DRAWINGS

FIG. 1 illustrates a side view of a CT scanner with a first arm in a CT scanning position;

FIG. 2 illustrates a computer employed with the CT scanner;

FIG. 3 illustrates a front view of the CT scanner with the first arm in the CT scanning position;

FIG. 4 illustrates a side view of the CT scanner with the first arm in a collapsed position; and

FIG. 5 illustrates a front view of the CT scanner with the first arm in the collapsed position.

### DETAILED DESCRIPTION OF THE PREFERRED EMBODIMENT

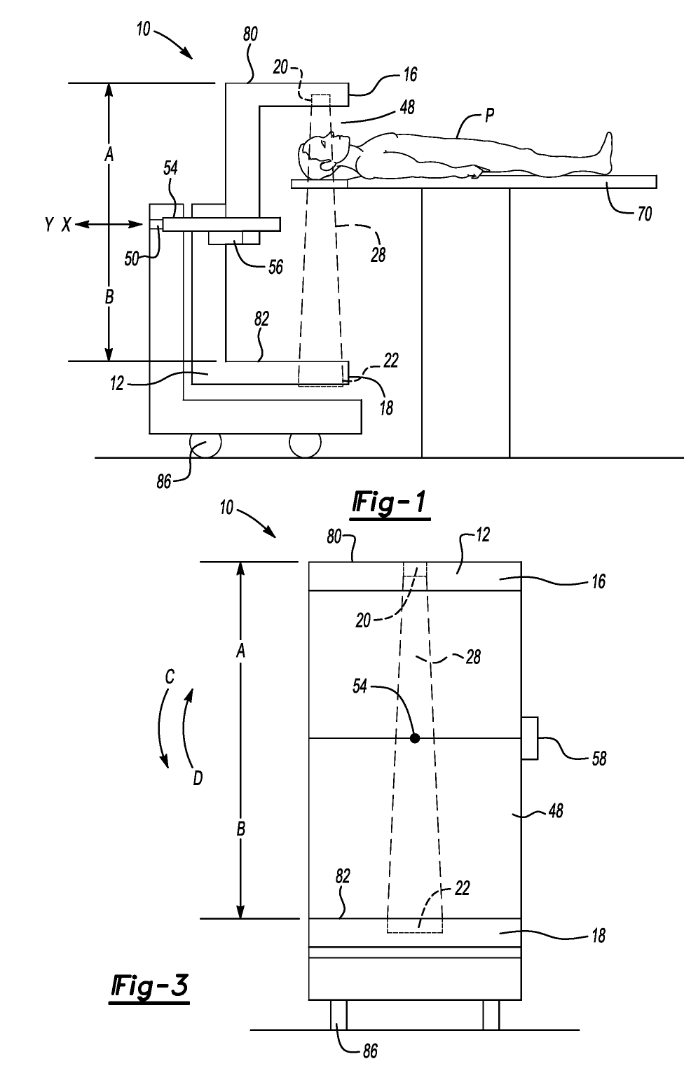

FIG. 1 illustrates a CT scanner 10 of the present invention. The CT scanner 10 includes a gantry 12 that supports and houses components of the CT scanner 10. In one example, the gantry 12 includes a first arm 16 and a second arm 18. For example, the first arm 16 and the second arm 18 are each substantially L-shaped. One of the first arm 16 and the second arm 18 houses an x-ray source 20 that generate x-rays 28. In one example, the x-ray source 20 is a cone-beam x-ray source. The other of the first arm 16 and the second arm 18 houses a complementary flat-panel detector 22. Although the illustrated example shows the first arm 16 including the x-ray source 20 and the second arm 18 including the x-ray detector 22, the opposite configuration is possible.

The x-rays 28 are directed toward the x-ray detector 22 which includes a converter (not shown) that converts the x-rays 28 from the x-ray source 20 to visible light, and an array of photodetectors behind the converter creates an image.

A part of the patient P is received in a space 48 defined between the first arm 16 and the second arm 18. A motor 50 rotates the gantry 12 about an axis of rotation X, and the x-ray detector 22 obtains a plurality of x-ray images of the patient P at the plurality of rotational positions. The axis of rotation X is positioned between the x-ray source 20 and the x-ray detector 22. In one example, the gantry 12 can be rotated approximately slightly more than 360° about the axis of rotation X. In one example, the axis of rotation X is substantially horizontal. In this example, the patient P is typically lying down on a table 70. Various configurations and types of x-ray sources 20 and detectors 22 can be utilized, and the invention is largely independent of the specific technology used for the CT scanner 10. The CT scanner 10 can also include wheels 86 that allow the CT scanner 10 to move.

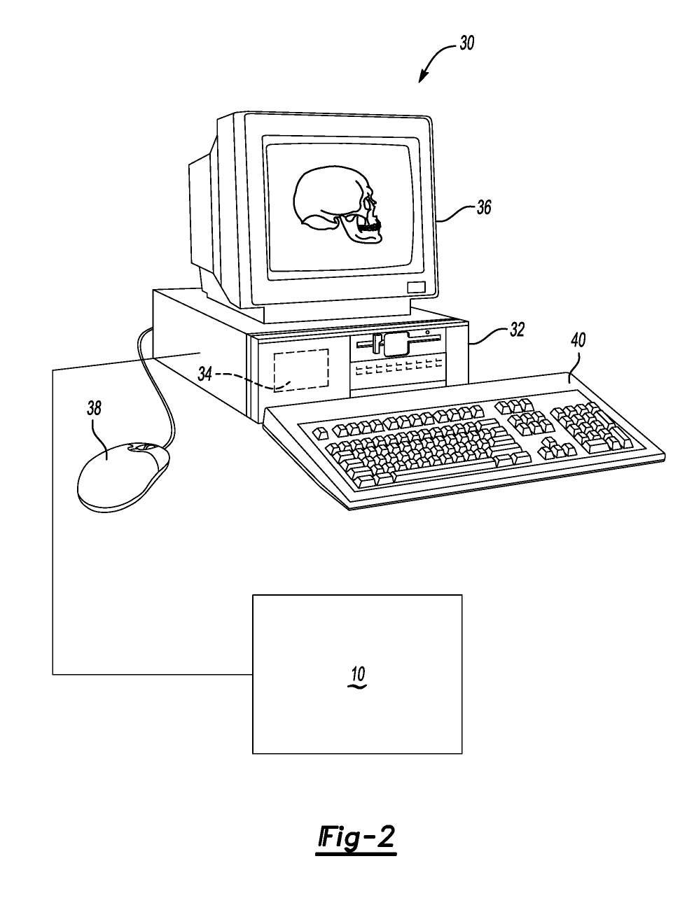

As shown schematically in FIG. 2, the CT scanner 10 further includes a computer 30 having a microprocessor or CPU 32, a storage 34 (memory, hard drive, optical, and/or magnetic, etc), a display 36, a mouse 38, a keyboard 40 and other hardware and software for performing the functions described herein. The computer 30 powers and controls the x-ray source 20 and the motor 50. The plurality of x-ray images are provided to the computer 30. The computer 30 generates a three-dimensional CT image from the plurality of x-ray images utilizing any known techniques and algorithms. The three-dimensional CT image is stored on the storage 34 of the computer 30 and can be displayed on the display 36 for viewing and/or manipulation.

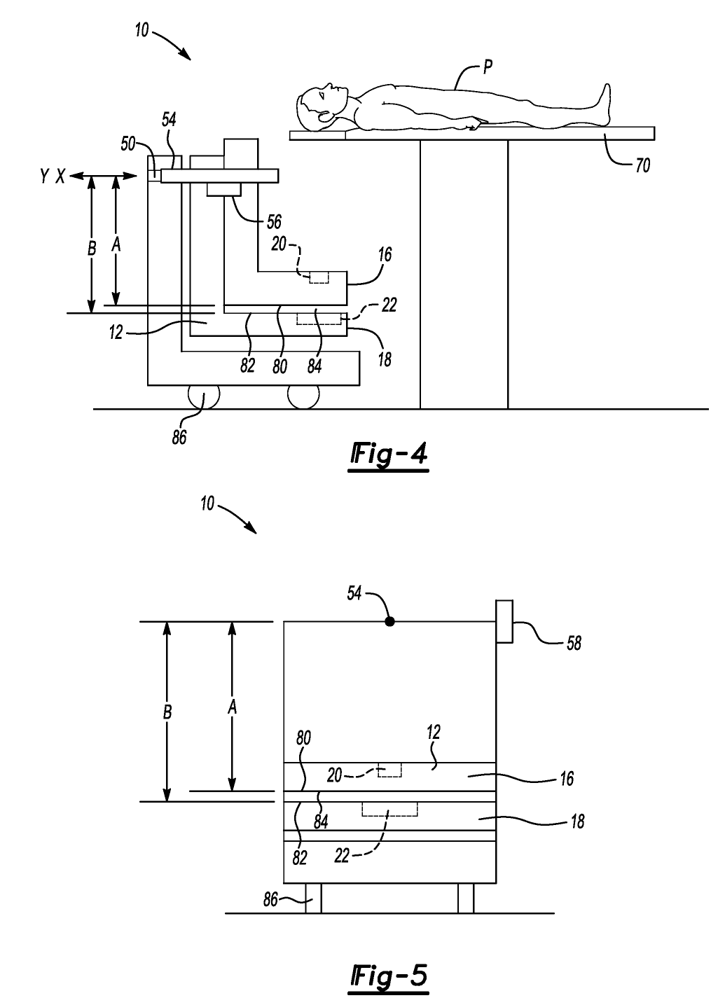

As shown in FIG. 1, the first arm 16 is rotatable relative to the second arm 18. The first arm 16 rotates about a pivot 54 defining an axis Y. The axis Y can be aligned with the axis of rotation X (as shown in FIGS. 1 and 4) or can be substantially parallel to the axis of rotation X. An outermost surface 80 of the first arm 16 extends a distance A from the axis Y, and an innermost surface 82 of the second arm 18 extends a distance B from the axis Y. The distance B is greater than the distance A.

As shown in FIGS. 1 and 3, during a CT scan, the first arm 16 of the gantry 12 is in a CT scanning position, and the first arm 16 and the second arm 18 define the C-shaped or a U-shaped gantry 12. The CT scan can be performed before the surgical procedure or during the surgical procedure. When the first arm 16 is in the CT scanning position, the first arm 16 and the second arm 18 are located on opposing sides of a horizontal plane that passes through the pivot 54. A lock 56 selectively secures the first arm 16 in the CT scanning position relative to the second arm 18. When a CT scan is to be obtained, a portion of the patient P is received in the space 48. The gantry 12 rotates about the axis of rotation X, and the CT scanner 10 obtains a plurality of x-ray images of the patient P, which are used to generate a three-dimensional CT image.

During the surgical procedure, the CT scanner 10 may be an obstacle. The first arm 16 is rotated about the pivot 54 relative to the second arm 18 to move the first arm 16 from the CT scanning position shown in FIGS. 1 and 3 to a collapsed position shown in FIGS. 4 and 5. The lock 56 is released, allowing the first arm 16 to rotate about the pivot 54. In one example, the first arm 16 rotates approximately 180° in a first direction C from the CT scanning position to the collapsed position. The first arm 16 can be moved from the CT scanning position to the collapsed position manually by the surgeon (for example, by grabbing a handle) or can be moved with a motor (not shown).

When the first arm 16 is in the collapsed position, the first arm 16 and the second arm 18 are located on a common side of the horizontal plane that passes through the pivot 54. As the distance B is greater than the distance A, the first arm 16 fits into the space 48 defined between the axis of rotation X and the second arm 18, allowing the first arm 16 to move to the collapsed position and providing additional space in the operating room. When in the collapsed position, the outermost surface 80 of the first arm 16 is spaced from the innermost surface 82 of the second arm 18 by a space 84. That is, the “L-shaped” first arm 16 is received inside the “L-shaped” the second arm 18.

In one example, a stop 58 prevents the first arm 16 from rotating more than 180° from the CT scanning position and the collapsed position. In another example, the CT scanner 10 does not include a stop, and the first arm 16 can rotate 360° about the pivot 54.

The lock 56 can secure the first arm 16 relative to the second arm 18 in the collapsed position. Alternatively, gravity can retain the first arm 16 in the collapsed position. Once collapsed, the CT scanner 10 could also be slid under the table 70 by rolling the CT scanner 10 on the wheels 86.

When an intra-operative CT scan is needed during the surgical procedure, the lock 56 is released, allowing the first arm 16 to rotate about the pivot 54 in a second direction D opposite to the first direction C from the collapsed position to the CT scanning position. In one example, the first arm 16 rotates approximately 180° in the second direction D from the collapsed position to the CT scanning position. The stop 58 prevents the first arm 16 from rotating more than 180° from the collapsed position to the CT scanning position. Once the first arm 16 is in the CT scanning position, the lock 56 can be used to secure the first arm 16 in the CT scanning position. An intra-operative CT scan of the patient P can then be taken.

By rotating the first arm 16 to the collapsed position, additional surgical space is available during the surgical procedure without requiring movement of the CT scanner 10. Therefore, the CT scanner 10 can be retained in a single position during the surgical procedure, ensuring the CT scanner 10 is in the same location for all intra-operative CT scans.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A CT scanner comprising:
a gantry rotatable about an axis of rotation, wherein the gantry includes a first arm and a second arm, and the first arm is rotatable about an axis relative to the second arm between a CT scanning position and a collapsed position;
an x-ray source housed in one of the first arm and the second arm to generate x-rays; and
an x-ray detector housed in the other of the first arm and the second arm.

2. The CT scanner as recited in claim 1 wherein the CT scanner obtains a plurality of x-ray images of a patient as the gantry rotates about the axis of rotation, a computer generates a three-dimensional CT image from the plurality of x-ray images, and the first arm is in the CT scanning position as the gantry rotates about the axis of rotation.

3. The CT scanner as recited in claim 1 wherein the gantry defines a C-shape when the first arm is in the CT scanning position.

4. The CT scanner as recited in claim 1 wherein the axis is substantially parallel to the axis of rotation.

5. The CT scanner as recited in claim 1 wherein the axis is aligned with the axis of rotation.

6. The CT scanner as recited in claim 1 wherein an outermost surface of the first arm extends a first distance from the axis and an innermost surface of the second arm extends a second distance from the axis, wherein the second distance is greater than the first distance.

7. The CT scanner as recited in claim 1 wherein the first arm rotates approximately 180° between the CT scanning position and the collapsed position.

8. The CT scanner as recited in claim 7 including a stop that prevents the first arm from rotating more than 180°.

9. The CT scanner as recited in claim 1 including a lock that secures the first arm in one of the CT scanning position and the collapsed position.

10. The CT scanner as recited in claim 1 wherein gravity retains the first arm in the collapsed position.

11. A method of rotating a portion of a CT scanner, the method comprising the steps of:
providing a gantry including a first arm and a second arm, wherein an x-ray source that emits x-rays is housed in one of the first arm and the second arm and an x-ray detector is housed in the other of the first arm and the second arm; and
rotating the first arm relative to the second arm about an axis between a CT scanning position and a collapsed position.

12. The method as recited in claim 11 including the steps of rotating the gantry about an axis of rotation, obtaining a plurality of x-ray images of a patient as the gantry rotates about the axis of rotation, and generating a three-dimensional CT image from the plurality of x-ray images, wherein the first arm is in the CT scanning position during the step of rotating.

13. The method as recited in claim 11 wherein the axis is substantially parallel to the axis of rotation.

14. The method as recited in claim 11 wherein the axis is aligned with the axis of rotation.

15. The method as recited in claim 11 wherein an outermost surface of the first arm extends a first distance from the axis and an innermost surface of the second arm extends a second distance from the axis, wherein the second distance is greater than the first distance.

16. The method as recited in claim 11 including the step of rotating the first arm approximately 180° between the CT scanning position and the collapsed position.

17. The method as recited in claim 16 including the step of preventing the first arm from rotating more than 180°.

18. The method as recited in claim 11 including the step of locking the first arm relative to the second arm in one of the CT scanning position and the collapsed position

19. The method as recited in claim 11 including the step of retaining the first arm in the collapsed position with gravity.
